(19) United States
(12) Patent Application Publication
(10) Pub. No.: US 2013/0045653 A1
(43) Pub. Date: Feb. 21, 2013

(54) PROTECTIVE SUIT FABRIC AND SPUN YARN USED FOR THE SAME

(71) Applicants: Masanobu Takahashi, Aichi (JP); Hideki Omori, Hyogo (JP)

(72) Inventors: Masanobu Takahashi, Aichi (JP); Hideki Omori, Hyogo (JP)

(73) Assignees: SABIC INNOVATIVE PLASTICS IP B.V., Bergen op Zoom (NL); THE JAPAN WOOL TEXTILE CO., LTD., Kobe-shi, Hyogo (JP)

(21) Appl. No.: 13/695,478

(22) PCT Filed: Jan. 12, 2012
(86) PCT No.: PCT/JP2012/050468

§ 371 Date: Oct. 31, 2012

(30) Foreign Application Priority Data
Jan. 27, 2011 (JP) 2011-014788

(51) Int. Cl. D02G 3/22; D02G 3/02; D03D 15/00; B32B 5/16; D04B 21/00

(52) U.S. Cl. 442/301; 428/221; 442/304; 428/377; 57/243

(57) ABSTRACT

A heat-resistant flame-retardant protective suit fabric of the present invention is formed of a uniform blended spun yarn including 25 to 75 mass % of polyetherimide fiber, 20 to 50 mass % of at least one fiber selected from wool and flame-retardant rayon, and 5 to 25 mass % of para-aramid fiber when the spun yarn is 100 mass %. The fabric experiences no heat shrinkage when exposed to a heat flux at 80 kW/m² ±5% for 3 seconds in accordance with ISO 9151 Determination of Heat Transmission on Exposure to Flame. And the char length is not more than 10 cm in the longitudinal and horizontal directions in the flammability test specified in JIS L 1091A-4. Thereby, the present invention provides a protective suit fabric that provides comfort in wearing even if the suit is worn in the hot seasons or even if the wearer perspires during exertion. The fabric has high heat resistance and high flame retardance, favorable dye affinity, and the fabric can be produced at a low cost. The present invention provides also a spun yarn used for the fabric.

### TECHNICAL FIELD

The present invention relates to a protective suit fabric and a spun yarn used for the same.

### BACKGROUND ART

Protective suits have been used widely, for example as work clothing worn by fire fighters, ambulance crews, rescue workers, maritime lifeguards, military, workers at oil-related facilities, and workers at chemical facilities. A para-aramid fiber is used in general for such a protective suit fabric that is required to have heat resistance and flame retardance. However, the para-aramid fiber is problematic in that it is expensive and poorly dyed. In order to cope with the problem, the inventors proposed a sheath-core spun yarn having a core of stretch-broken spun yarn of a para-aramid fiber and a sheath of a meta-aramid fiber, a flame-retardant acrylic fiber or a polyetherimide fiber (Patent document 1). A blended spun article of a heat-resistant fiber such as para-aramid fiber and a carbonizable flame-retardant fiber such as flame-retardant rayon or flame-retardant vinylon is proposed in Patent Document 2.

However, the fiber compositions proposed by Patent documents 1 and 2 are problematic in that for example the wearer will perspire during exertion and the comfort in wearing is not so favorable in the hot seasons.

### PRIOR ART DOCUMENT

### Patent Document

Patent document 1: WO 2009/014007

Patent document 2: JP 2008-101294 A

### DISCLOSURE OF INVENTION

### Problem to be Solved by the Invention

For solving the above-mentioned problems, the present invention provides a protective suit fabric that provides comfort in wearing even if the suit is worn in the hot seasons or even if the wearer perspires during exertion. The fabric has high heat resistance and high flame retardance, favorable dye affinity, and the fabric can be produced at a low cost. The present invention also provides a spun yarn used for the fabric.

### Means for Solving Problem

A heat-resistant flame-retardant protective suit fabric of the present invention is formed of a uniform blended spun yarn which includes 25 to 75 mass % of polyetherimide fiber, 20 to 50 mass % of at least one fiber selected from wool and flame-retardant rayon, and 5 to 25 mass % of para-aramid fiber when the spun yarn is 100 mass %. The fabric experiences no heat shrinkage when exposed to a heat flux at 80 kW/m²±5% for 3 seconds in accordance with ISO 9151 Determination of Heat Transmission on Exposure to Flame. And the char length is not more than 10 cm in the longitudinal and horizontal directions in the flammability test specified in JIS L 1091A-4.

The spun yarn of the present invention is a spun yarn used for the protective suit fabric. The spun yarn is a uniform blended spun yarn including 25 to 75 mass % of polyetherimide fiber, 20 to 50 mass % of at least one fiber selected from wool and flame-retardant rayon, and 5 to 25 mass % of para-aramid fiber when the spun yarn is 100 mass %.

### Effects of the Invention

The protective suit fabric of the present invention is formed of a uniform blended spun yarn including 25 to 75 mass % of polyetherimide fiber, 20 to 50 mass % of at least one fiber selected from wool and flame-retardant rayon, and 5 to 25 mass % of para-aramid fiber. Thereby, even when being exposed to a high temperature heat flux, it is not shrunk by heat and is less carbonized. The comfort in wearing is favorable even if the wearer perspires during exertion and if the fabric is used in the hot seasons. Further, the cost for production can be reduced. The spun yarn of the present invention has high heat retardance and high flame retardance, favorable dye affinity, and it can be produced at a low cost.

### DESCRIPTION OF THE INVENTION

The protective suit fabric of the present invention is formed of a uniform blended spun yarn that includes 25 to 75 mass % of polyetherimide fiber, 20 to 50 mass % of at least one fiber selected from wool and flame-retardant rayon, and 5 to 25 mass % of para-aramid fiber when the spun yarn is 100 mass %. Preferably, it is a uniform blended spun yarn including 35 to 75 mass % of polyetherimide fiber, 20 to 40 mass % of at least one fiber selected from wool and flame-retardant rayon, and 5 to 25 mass % of para-aramid fiber. It is preferable that the polyetherimide single fiber has a fineness of not more than 3.9 decitex (3.5 deniers) and more preferably not more than 2.8 decitex (2.5 deniers). When the fineness is not more than 3.9 decitex (3.5 deniers), the fiber has flexibility and preferable feeling, and it can be applied suitably to work clothing. A preferable average fiber length of the polyetherimide fiber is in a range of 30 to 220 mm, and more preferably, in a range of 80 to 120 mm, and particularly preferably in a range of 90 to 110 mm. The polyetherimide fiber having the fiber length in the range can be spun easily. The polyetherimide fiber, the wool fiber and the para-aramid fiber are blended uniformly in order to make a woven fabric or a knitted fabric.

Hereinafter, the respective fibers will be described.

1. Polyetherimide Fiber

An example of the polyetherimide fiber is “Ultem” manufactured by Sabic Innovative Plastics (limiting oxygen index (LOI): 32). This fiber has a tensile strength of about 3 cN/decitex.

2 Wool

Commonly-used merino wool or the like can be used. The wool can be used in a natural state. Alternatively, wool that has been dyed as a fiber or as a yarn (hereinafter, it is referred to as yarn-dyed product) can be used. It is preferable that a yarn-dyed product is used. For the wool, unmodified wool may be used. Alternatively, wool that has been modified by for example removing the surface scales for shrink proofing may be used. Such an unmodified or modified wool is used to improve hygroscopicity and to shield a radiant heat so that the comfort in wearing is kept preferable despite wetting from sweat during exertion under a high-temperature and severe environment, thereby exhibiting heat resistance for protecting the human body. The above-mentioned effect can be obtained also by using wool that has been subjected to a ZIRPRO process (a process with titanium and zirconium salt). This process developed by the International Wool Standard Secretariat is well known as a process for providing flame-retardance to wool.

3. Flame-Retardant Rayon

Examples of flame-retardant rayon include a rayon that has been subjected to a PROBAN process (an ammonium curing process using tetrakis hydroxymethyl phosphonium salt developed by Albright & Wilson Ltd.), a rayon that has been subjected to a Pyrovatex CP process (process with N-methylol dimethylphosphonopropionamide) developed by Ciba-Geigy, and “Viscose FR (trade name) manufactured by Lenzing AG in Austria.

4. Para-Aramid Fiber

Examples of aramid fibers include a para-aramid fiber and a meta-aramid fiber. In the present invention, the para-aramid fiber is used. The para-aramid fiber has high tensile strength (for example, “Technora” manufactured by Thijin, Ltd., 24.7 cN/decitex; “Kevlar” manufactured by DuPont, 20.3 to 24.7 cN/decitex). In addition, the thermal decomposition starting temperature is high (about 500° C. for both of the above products) and the limiting oxygen index (LOI) is in a range of 25-29, and thus the products can be used preferably for a heat-resistant fabric and heat-resistant protective suits. It is preferable that the single fiber fineness of the para-aramid fiber is in a range of 0.5 to 6 deci tex, and more preferably, in a range of 1 to 4 deci tex.

5. Blend Rates of Respective Fibers

The protective suit fabric of the present invention is formed of a uniform blended spun yarn that includes 25 to 75 mass % of polyetherimide fiber, 20 to 50 mass % of at least one fiber selected from wool and flame-retardant rayon, and 5 to 25 mass % of para-aramid fiber. More preferably, it includes 35 to 75 mass % of polyetherimide fiber, 20 to 40 mass % of at least one fiber selected from wool and flame-retardant rayon, and 5 to 25 mass % of para-aramid fiber. Further preferably, it includes 30 to 70 mass % of polyetherimide fiber, 25 to 45 mass % of at least one fiber selected from wool and flame-retardant rayon, and 5 to 25 mass % of para-aramid fiber. When the fiber contents are in the above-mentioned ranges, the comfort in wearing is favorable, the heat resistance and flame retardance are high, the dye affinity is favorable, and the production cost can be reduced. When the content of the para-aramid fiber is less than the range, heat shrinkage at high temperature is increased, and it is not preferable. When the content of the para-aramid fiber exceeds the range, the cost is increased. When the content of the polyetherimide fiber is less than the range, the dye affinity deteriorates. When the content of the polyetherimide fiber exceeds the range, the heat shrinkage at high temperature is increased, and it is not preferable. When the content of the at least one fiber selected from wool and flame-retardant rayon is less than the range, the comfort in wearing deteriorates, and it is not preferable. When the content of the at least one fiber selected from wool and flame-retardant rayon exceeds the above-mentioned range, the heat resistance and flame retardance deteriorate, and it is not preferable.

More preferably, the uniform blended spun yarn includes 25 to 74 mass % of polyetherimide fiber, 20 to 50 mass % of at least one fiber selected from wool and flame-retardant rayon, 5 to 25 mass % of para-aramid fiber, and 0.1 to 1 mass % of antistatic fiber. When the contents are in these ranges, antistatic effects will be provided in addition to the above mentioned effects.

For making a blended yarn, according to a usual spinning method, the fibers are blended in steps such as carding, roving, drafting or any other preceding steps so as to manufacture a spun yarn. The spun yarn can be used as a single yarn or a plurality of yarns can be twisted together.

6. Two-Fold Yarn

Two-fold yarn is a yarn formed by twisting/plying two single yarns. Two-fold yarn is used for the warp in a woven fabric of hydrophobic fibers represented by wool, since the two-fold yarn has at least doubled strength when compared to a single yarn and thereby can provide a conjugative power to prevent yarn breakage during weaving, and irregularity in thickness of the single yarn is compensated to provide a delicate mesh texture to the woven fabric. For example, the two-fold yarn is produced by use of a twister such as a double-twister.

In a woven fabric of a hydrophilic fiber represented by cotton, a sized single yarn is used for the warps. In weaving, the adjacent warps rub each other repeatedly at every shedding motion of the loom, and rotate in a direction to reversely twist every time tensile force is applied. As a result, the surface fuzzes of the warps get entangled. Thus, further fuzzes are drawn out from the yarns so as to degrade the conjunctive power. Finally, the yarn will be broken to stop the loom. If the fiber is hydrophilic, starches or the like easily adhere to the yarn. Since the surface fuzzes are hardened with the sizing agent, the conjugative power will not deteriorate during the weaving, and no breakage of the warps occurs. Furthermore, the thus woven fabric later can be desized easily by washing with water during a refining step.

In contrast, as wool and many kinds of synthetic fibers are hydrophobic, starches or the like do not work efficiently. Even if a special sizing agent could be applied to the yarn surface, at present there has been found no method to desize in an easy and inexpensive manner such as washing in water during the refining step after the weaving.

Warp breakage in a loom depends considerably on the conjugative power regarding the rubbing, entanglement and peeling of the surface fuzzes rather than the strength (cN/deci tex) of the single fiber that forms the yarn. Needless to note, polyester whose single fiber strength is 5 times the wool and also para-aramid whose single fiber strength is 5 times the polyester are also hydrophobic. Therefore, it is preferable that warps of these fibers are prepared as two-fold yarns.

The twist direction (S-twist or Z-twist) and the twist factor K₂ of a two-fold yarn with respect to the twist direction and the twist factor K₁ of a single yarn are set depending on the type of the fabric to be woven. Here, a wool woven fabric will be explained as an example. For obtaining crimpy touch or crispy touch for georgette or voile, with respect to Z-twisted single yarn, the two-fold yarn is also Z-twisted and K₂ is set to be larger so as to make a so-called high twisted yarn. In contrast, in a case of saxony or flannel, it is preferable that the surface of the woven fabric is napped sufficiently to provide softness, bulkiness and shiny smoothness. In such a case, the single yarn is Z-twisted, while the two-fold yarn is S-twisted to set a smaller K₂ in order to make a so called a loose twisted yarn, thereby promoting felting and raising.

In the present invention, it is preferable that the uniform blended spun yarn is formed of a two-fold yarn, a twist factor Ks₁ of single yarn is in a range of 256 to 275, the two-fold yarn is twisted in a direction opposite to the direction for twisting the single yarn, and a twist factor K_{S2} of the two-fold yarn is in a range of 174 to 188. The twist factor Ks₁ of the single yarn and the twist factor Ks₂ of the two-fold yarn are calculated by equations below.

Ks₁=T₁·√S₁

Ks₁=T₂·√S₂

In the equations, T₁ indicates a twist number (time/m) of the single yarn, T₂ indicates a twist number (time/m) of the two-fold yarn, S₁ indicates a single yarn fineness (tex) and S₂ indicates a two-fold yarn fineness (tex).

Table 1 below shows twist directions and preferred ranges of twist numbers, twist factors and yarn finenesses of the single yarn and the two-fold yarn of the respective yarns.

TABLE 1

| | Uniform blended | Uniform blended |
|---|---|---|
| | spun yarn (single) | spun yarn (two-fold) |
| Twist direction | Z | S |
| Twist number T₁, T₂ | T₁ = 340-870 | T₂ = 470-840 |
| (time/m) | | |
| Twist factor Ks₁, Ks₂ | Ks₁ = 2560-2750 | Ks₂ = 3490-3760 |
| Yarn fineness S₁, S₂ (tex) | S₁ = 10-56 | S₂ = 20-112 |

When the values of these items are in the above-identified ranges, the twist structure is stable, the yarn conjugative property is high, and thus a woven fabric with a delicate mesh texture and soft feeling can be obtained.

In an expression of count of the spun yarn, it is preferable that the twist factor Kc₁ of the single yarn is in a range of 81-87, the two-fold yarn is twisted in a direction opposite to the direction for twisting the single yarn, and the twist factor Kc₂ of the two-fold yarn is in a range of 78-84. The twist factor Kc₁ of the single yarn and the twist factor Kc₂ of the two-fold yarn are calculated by equations below.

Kc₁=T₁/√C₁

Kc₂=T₂/√C₂

Here, T₁ indicates a twist number (time/m) of the single yarn, T₂ indicates a twist number (time/m) of the two-fold yarn, and C₁ indicates a single yarn count (m/g).

Table 2 below shows twist directions and preferred ranges of twist numbers, twist factors and yarn counts of the respective yarns.

TABLE 2

| | Uniform blended | Uniform blended |
|---|---|---|
| | spun yarn (single) | spun yarn (two-fold) |
| Twist direction | Z | S |
| Twist number T₁, T₂ | T₁ = 340-870 | T₂ = 330-840 |
| (time/m) | | |
| Twist factor Kc₁, Kc₂ | K₁ = 81-87 | K₂ = 78-84 |
| Metric count C₁, C₂ (g/m) | C₁ = 1/18*¹-1/100 | C₂ = 2/18*²-2/100 |

Note 1:
this indicates a single yarn of 1 g per 18 m in length
Note 2:
this indicates a two-fold yarn of 2 g per 18 m in length

The two-fold yarns are used as warps and wefts to make a woven fabric. Examples of the woven fabric texture include plain weave, twill weave, and satin weave. In a case of knitted fabric texture, any of flat knitting, circular knitting, and warp knitting can be applied. There is no particular limitation on the knitted texture. When air is to be included in the knitted fabric, a double linkage pile fabric is formed.

It is preferable that the weight per unit (metsuke) of the protective suit fabric of the present invention is in a range of 100 to 340 g/m², so that lighter and more comfortable work clothing can be provided. It is more preferable that the range is 140 to 300 g/m², and particularly preferably 180 to 260 g/m².

The protective suit fabric of the present invention experiences no heat shrinkage when exposed for 3 seconds to a heat flux at 80 kW/m²±5% in accordance with ISO 9151 Determination of Heat Transmission on Exposure to Flame, and in a flammability test as specified in JIS L 1091A-4 (vertical method, 1992, flame contact: 12 seconds), its char length is not more than 10 cm in both the longitudinal and horizontal directions. The fabric experiences no or reduced shrinkage by heat even if it is exposed to high temperature, and the fabric is flame retardant, so that the comfort in wearing is kept preferable despite wetting from sweat during exertion under a high-temperature and severe environment.

It is preferable that an antistatic fiber further is added to the fabric. This is to inhibit the charging of the fabric when the final product is in use. Examples of the antistatic fiber include a metal fiber, a carbon fiber, a fiber in which metallic particles and carbon particles are mixed, and the like. The antistatic fiber preferably is added in a range of 0.1 to 1 mass % relative to the spun yarn, and more preferably in a range of 0.3 to 0.7 mass %. The antistatic fiber may be added at the time of weaving. For example, 0.1 to 1 mass % of “Beltron” manufactured by KB Seiren Ltd., “Clacabo” manufactured by Kuraray Co., Ltd., a carbon fiber or a metal fiber may be added.

The polyetherimide fibers can be dyed as a fiber, as a yarn or as a fabric. Since the para-aramid fiber is poorly dyed, preferably it is spun-dyed in advance. In this context, spin-dyeing indicates coloring a polymer with a pigment or a coloring agent at a stage prior to the spinning step.

### EXAMPLES

The present invention will be described below in further detail by way of Examples. The measurement method used in the Examples and Comparative Examples of the present invention are as follows.

### (1) Heat Shrinkage Test

Heat shrinkage was measured at the time of exposure for 3 seconds to a heat flux at 80 kW/m²±5% in accordance with ISO 9151 Determination of Heat Transmission on Exposure to Flame.

### (2) Burn Resistance

The char length created by bringing a flame of a Bunsen burner into contact for 12 seconds with the lower end of a woven fabric sample oriented vertically, the afterflame time after the flame was removed, and the afterglow time were measured according to the method specified in JIS L 1091A-4.

### (3) Washing Resistance

The fabric was washed five times in accordance with ISO 6330-1984, 2A-E specified in ISO 11613-1999 as the international performance standards.

### (4) Electrification Voltage Test

The voltage immediately after electrification was measured according to the method for a frictional electrification attenuation measurement specified in JIS L1094 5.4.

### (5) Other Physical Properties

The other physical properties were measured in accordance with JIS or the industry standards.

### Example 1

1. Applied Fibers

### (1) Polyetherimide Fiber

For a polyetherimide fiber, “Ultem” manufactured by Sabic Innovative Plastics (limiting oxygen index (LOI): 32; a single fiber fineness: 3.3 deci tex (3 deniers) and average fiber length: 89 mm) was used, and the fiber was dyed to olive-green color. A jet dyeing machine manufactured by Nissen Corporation was used as a dyeing machine, and dyes and other additives (Kayaron Polyester Yellow FSL (Nippon Kayaku Co., Ltd.) 3.60% o.w.f., Kayaron Red SSL (Nippon Kayaku Co., Ltd.) 0.36% o.w.f., Kayaron Polyester Blue SSL (Nippon Kayaku Co., Ltd.) 1.24% o.w.f., acetic acid (68 wt%) 0.0036% o.w.f., and sodium acetate 0.0067% o.w.f) were added, and the dyeing treatment was carried out at 135° C. for 60 minutes.

### (2) Wool Fiber

For the wool fiber, an unmodified merino wool produced in Australia (average fiber length: 75 mm) was used, which was dyed to olive-green color by an ordinary method by using an acid dye.

### (3) Para-Aramid Fiber

For the para-aramid fiber, “Technora” (trade name) manufactured by Teijin, Ltd. (fineness: 1.7 deci tex (1.5 deniers), average fiber length: 77 mm, spun-dyed) was used.

### (4) Antistatic Fiber

For the antistatic fiber, “Beltron” (trade name) manufactured by KB Seiren Ltd., having a single fiber fineness of 5.6 deci tex (5 deniers) and an average fiber length of 89 mm was used.

2. Manufacture of Blended Spun Yarn

For the fiber materials, 49.5 mass % of yarn-dyed polyetherimide fiber, 30 mass % of yarn-dyed wool, 20 mass % of para-aramid fiber (spun-dyed), and 0.5 mass % of antistatic fiber were prepared. These fibers were introduced separately into a card so as to open the fibers and to make a fibrous web, which then was blended using a sliver. The blended yarns were subjected to a fore-spinning step and a fine spinning step, and thereby a spun yarn (two-fold yarn) having a metric count of 44 (2/44) was manufactured to be used as the warp. The weft was prepared from the same fibers in the same manner. Table 3 shows the twist directions, the twist numbers, the twist factors and the yarn counts of the respective yarns.

TABLE 3

| | Uniform blended | Uniform blended |
|---|---|---|
| | spun yarn (single) | spun yarn (two-fold) |
| Twist direction | Z | S |
| Twist number (time/m) | 560 | 540 |
| Twist factor Ks₁, Ks₂ | Ks₁ = 2670 | Ks₂ = 3640 |
| Fineness (tex) | 22.7 | 45.5 |
| Twist factor Kc₁, Kc₂ | Kc₁ = 84 | Kc₂ = 81 |
| Metric count (g/m) | 1/44 | 2/44 |
| Yarn strength (g) | 338.2 | 787.6 |
| Yarn elongation (%) | 3.7 | 4.6 |

3. Manufacture of Woven Fabric

Using the spun yarns for the warp and the weft, a woven fabric having a 1/2 twill weave texture was manufactured with a rapier loom.

4. Measurement

This woven fabric did not experience any heat shrinkage when exposed for 3 seconds to a heat flux at 80 kW/m²±5% in accordance with ISO 9151 Determination of Heat Transmission on Exposure to Flame, and in a flammability test as specified in JIS L 1091A-4, its char length was not more than 10 cm in both the longitudinal and horizontal directions. The appearance of the woven fabric was favorable. The physical properties and the testing methods are shown in Table 4.

TABLE 4

| Test item | | Measured value | Testing method |
|---|---|---|---|
| Unit weight | Normal state | 220.1 g/m² | JIS L 1096-8.4.2 |
| Pick density | Warp | 238 number/10 cm | JIS L 1096-8.6.1 |
| | Weft | 226 number/10 cm | |
| Tensile strength | Warp | 1310N | JIS L 1096-8.12.1a (method A) |
| | Weft | 1190N | |
| Tensile elongation | Warp | 16.3% | JIS L 1096-8.12.1a (method A) |
| | Weft | 15.0% | |
| Tear strength (A-2) | Warp | 76.6N | JIS L 1096-8.15.2 (method A-2) |
| | Weft | 63.5N | |
| Dimensional change (method C) | Warp | −0.4% | JIS L 1096-8.64.4 (method C) |
| | Weft | −0.1% | |
| Washing dimensional change | | | |
| 5 times | Warp | −2.3% | ISO 11613-1999 |
| 5 times | Weft | −1.9% | ISO 6330 2A-E 5 times |
| 5 times | Appearance | grades 3-4 | |
| Heat resistance Shrinkage rate | Warp | −2.0% | ISO 11613-1999 Annex A |
| | Weft | −1.0% | |
| Frictional electrification attenuation | | | |
| Immediately after | Warp | −620 V | JIS L 1094.5.4 |
| Immediately after | Weft | −390 V | |
| Heat shrinkage | Warp | No | exposed to a heat flux at 80 kW/m² ± |
| | Weft | No | 5% for 3 seconds in |
| | | | accordance with ISO 9151 |
| | | | Determination of Heat |
| | | | Transmission on Exposure to |
| | | | Flame |
| Flame resistance | | | |
| Char length | Warp | 5.1 cm | ISO 11613-1999→in a case of |
| Char length | Weft | 4.4 cm | afterflame·afterglow time of 0 |
| Afterflame | Warp | 0.0 sec. | second, JIS L 1091A-4 alternate |
| Afterflame | Weft | 0.0 sec. | method (Annex 8), year of 1992 |
| Afterglow | Warp | 0.8 sec. | flame contact: 12 seconds |
| Afterglow | Weft | 0.9 sec. | (vertical method) |

Ten workers at a chemical facility took part in a one-month wear test of work clothing made of the woven fabric manufactured through the above-mentioned process. The workers at this facility ordinarily wear working cloth made of a material composed of 50 mass % of flame-retardant acrylic fiber and 50 mass % of flame-retardant cotton fiber (hereinafter, referred to as ‘acrylic/cotton’). All of the workers assessed that the comfort of the work clothing for the wear test was superior to that of their conventional work clothing. The grounds for the favorable assessment on the comfort are: the clothing maintains warmth despite perspiration during exertion and it is less chilly; it is not sticky; it is quick-drying; it is wrinkle-resistant; it keeps its shape, and the like. For reference, the fabric made of 50 mass % of acrylic fiber and 50 mass % of cotton fiber did not experience any heat shrinkage in the ISO 9151 Determination of Heat Transmission on Exposure to Flame, and the flammability according to JIS L 1091A-4 was as follows. Char length for warp: 8.7 cm, char length for weft: 8.4 cm, afterflame time for warp: 0 second, afterflame time for weft: 0 second, afterglow time for warp: 2.8 seconds, and afterglow time for weft: 3.1 seconds.

### Example 2

Example 2 was carried out similarly to Example 1 except that the mixture contents of the fibers were as shown in Table 5.

TABLE 5

| | Fiber type [mass %] | | | | | | Result | | | |
|---|---|---|---|---|---|---|---|---|---|---|
| Test | PEI | Wool | Para- | Meta- | Flame-retardant | Antistatic | Heat | Char length [cm] | | Dye affinity |
| No. | fiber | fiber | Aramid | aramid | acrylic | fiber | shrinkage | Warp | Weft | (appearance) |
| 2-1* | 74.5 | 25.0 | — | — | — | 0.5 | Yes | 15.2 | 14.8 | Favorable |
| 2-2* | 67.0 | 30.0 | 2.5 | — | — | 0.5 | Yes | 12.4 | 11.5 | Favorable |
| 2-3 | 59.5 | 35.0 | 5.0 | — | — | 0.5 | No | 9.8 | 9.1 | Favorable |
| 2-4 | 59.5 | 30.0 | 10.0 | — | — | 0.5 | No | 6.0 | 5.4 | Favorable |
| 2-5* | 59.5 | 30.0 | — | 10.0 | — | 0.5 | Yes | 14.5 | 12.7 | Favorable |
| 2-6 | 54.5 | 30.0 | 15.0 | — | — | 0.5 | No | 5.6 | 5.0 | Favorable |
| 2-7 | 49.5 | 30.0 | 20.0 | — | — | 0.5 | No | 5.1 | 4.4 | Favorable |
| 2-8 | 64.5 | 25.0 | 10.0 | — | — | 0.5 | No | 6.2 | 5.3 | Favorable |
| 2-9* | 39.5 | 30.0 | 30.0 | — | — | 0.5 | No | 4.6 | 4.0 | Unfavorable |
| 2-10* | 74.5 | 15.0 | 10.0 | — | — | 0.5 | No | 8.5 | 9.3 | Favorable |
| 2-11* | 27.0 | 52.5 | 20.0 | — | — | 0.5 | No | 21.8 | 20.9 | Favorable |
| 2-12* | — | 25.0 | — | — | 74.5 | 0.5 | Yes | 16.2 | 16.7 | Favorable |
| 2-13* | — | 15.0 | — | 20.0 | 64.5 | 0.5 | Yes | 15.6 | 14.4 | Favorable |

(Note 1)
*in each Test No. indicates Comparative Example.
(Note 2)
PEI is the abbreviation for polyetherimide.

Table 5 illustrates that the fabrics of the present invention did not experience any heat shrinkage, the char length was not more than 10 cm, the heat resistance and the flame retardance were high and the dye affinity (appearance) was favorable.

In contrast, Comparative Examples each had the following problems.
(1) Test No. 2-1 composed of only a polyetherimide fiber and wool was not favorable because it was shrunk by heat and the char length was great.
(2) Test No. 2-2 was not favorable because the content of para-aramid fiber was extremely small, and thus the fabric was shrunk by heat.
(3) Test Nos. 2-4 and 2-5 showed that blending with para-aramid fiber was preferable to blending with meta-aramid fiber since the heat shrinkage was suppressed and the char length was decreased.
(4) Test No. 2-9 was not favorable because the excessive para-aramid fiber made the spun-dyed color noticeable, and the appearance was unfavorable. Furthermore the cost was raised.
(5) Test No. 2-10 containing an extremely small amount of wool was not favorable, since it was not comfortable in wearing.
(6) Test No. 2-11 containing an extremely large amount of wool was unfavorable, since the char length was increased.
(7) Test No. 2-12 containing flame-retardant acrylic fiber blended in place of polyetherimide fiber was not favorable since heat shrinkage was not suppressed and the char length was increased.
(8) Test No. 2-13 containing flame-retardant acrylic fiber and meta-aramid fiber in place of polyetherimide fiber was not favorable since heat shrinkage was not suppressed and the char length was increased.

### Example 3

In place of the wool in Example 1, “Viscose FR” (trade name) manufactured by Lenzing AG in Austria (average fiber length: 75 mm, average fineness: 3.3 deci tex) was used. 39.5 mass % of this “Viscose FR”, 50 mass % of the yarn-dyed polyetherimide fiber of Example 1, 10 mass % of para-aramid fiber (spun-dyed), and 0.5 mass % of the antistatic fiber were introduced separately into a card so as to open the fibers and to make a fibrous web, which then was blended using a sliver. The blended yarns were subjected to a fore-spinning step and a fine spinning step and thereby a spun yarn (two-fold yarn) having a metric count of 44 (2/44) was manufactured to be used as the warp. The weft was prepared from the same fibers in the same manner. Table 6 shows the twist directions, the twist numbers, the twist factors and the yarn counts of the respective yarns.

TABLE 6

| | Uniform blended | Uniform blended |
|---|---|---|
| | spun yarn (single) | spun yarn (two-fold) |
| Twist direction | Z | S |
| Twist number (time/m) | 560 | 540 |
| Twist factor Ks₁, Ks₂ | Ks₁ = 2670 | Ks₂ = 3640 |
| Fineness (tex) | 22.7 | 45.5 |
| Twist factor Kc₁, Kc₂ | Kc₁ = 84 | Kc₂ = 81 |
| Metric count (g/m) | 1/44 | 2/44 |
| Yarn strength (g) | 313.9 | 676.4 |
| Yarn elongation (%) | 4.8 | 5.3 |

3. Manufacture of Woven Fabric

Using the spun yarns for the warp and the weft, a woven fabric having a 1/2 twill weave texture and a woven fabric having a 1/1 plain weave texture were manufactured with a rapier loom. The densities of pick numbers of warps and wefts were varied. Test No. 3-1 indicates a woven fabric having a 1/2 twill weave texture whose mass par unit area is 230.3 g/m², and test No. 3-2 indicates a woven fabric having a 1/1 plain weave texture whose mass par unit area is 192.7 g/m².

4. Measurement

These woven fabrics did not experience any heat shrinkage when exposed for 3 seconds to a heat flux at 80 kW/m²±5% in accordance with ISO 9151 Determination of Heat Transmission on Exposure to Flame, and in a flammability test as specified in JIS L 1091A-4, its char length was not more than 10 cm in both the longitudinal and horizontal directions. The appearances of the woven fabrics were favorable. The physical properties and the testing methods are shown in Table 7.

TABLE 7

| Test item | | Test No. 3-1 | Test No. 3-2 | Testing method |
|---|---|---|---|---|
| Unit weight | Normal state | 230.3 g/m² | 192.7 g/m² | JIS L 1096-8.4.2 |
| Pick density | Warp | 242 number/10 cm | 212 number/10 cm | JIS L 1096-8.6.1 |
| | Weft | 232 number/10 cm | 190 number/10 cm | |
| Tensile strength | Warp | 776N | 703N | JIS L 1096-8.12.1a (method |
| | Weft | 815N | 638N | A) |
| Tensile elongation | Warp | 17.1% | 18.2% | JIS L 1096-8.12.1a (method |
| | Weft | 17.8% | 16.4% | A) |
| Tear strength (A-2) | Warp | 47.3N | 48.1N | JIS L 1096-8.15.2 (method |
| | Weft | 45.9N | 37.9N | A-2) |
| Dimensional change | Warp | −0.5% | −0.3% | JIS L 1096-8.64.4 (method |
| (method C) | Weft | 0.1% | −0.4% | C) |
| Washing dimensional change | | | | |
| 5 times | Warp | −2.2% | −2.1% | ISO 11613-1999 |
| 5 times | Weft | −1.2% | −0.8% | ISO 6330 2A-E 5 times |
| 5 times | Appearance | Grade 4 | Grade 4 | |
| Heat resistance | Warp | −3.0% | −3.0% | ISO 11613-1999 Annex A |
| Shrinkage rate | Weft | −3.0% | −2.0% | |
| Frictional electrification attenuation | | | | |
| Immediately after | Warp | −80 V | −80 V | JIS L 1094.5.4 |
| Immediately after | Weft | −110 V | −70 V | |
| Heat shrinkage | Warp | No | No | exposed to a heat flux at 80 kW/m² ± |
| | Weft | No | No | 5% for 3 seconds in |
| | | | | accordance with ISO 9151 |
| | | | | Determination of Heat |
| | | | | Transmission on Exposure to |
| | | | | Flame |
| Flame resistance | | | | |
| Char length | Warp | 6.1 cm | 4.9 cm | ISO 11613-1999→in a case |
| Char length | Weft | 5.0 cm | 5.2 cm | of afterflame·afterglow time |
| Afterflame | Warp | 0.0 sec. | 0.0 sec. | of 0 second, JIS L 1091A-4 |
| Afterflame | Weft | 0.0 sec. | 0.0 sec. | alternate method (Annex 8), |
| Afterglow | Warp | 0.8 sec. | 0.7 sec. | year of 1992 flame contact: |
| Afterglow | Weft | 0.8 sec. | 0.7 sec. | 12 seconds (vertical method) |

Ten workers at a chemical facility took part in a one-month wear test of work clothing made of the woven fabric manufactured through the above-mentioned process. The workers at this facility ordinarily wear working cloth made of a material composed of 50 mass % of flame-retardant acrylic fiber and 50 mass % of flame-retardant cotton fiber (hereinafter, referred to as ‘acrylic/cotton’). All of the workers assessed that the comfort of the work clothing for the wear test was superior to that of their conventional work clothing. The grounds for the favorable assessment on the comfort are; the clothing maintains warmth despite perspiration during exertion and it is less chilly; it is not sticky; it is quick-drying; it is wrinkle-resistant; it keeps its shape, and the like. For reference, the fabric made of 50 mass % of acrylic fiber and 50 mass % of cotton fiber did not experience any heat shrinkage in the ISO 9151 Determination of Heat Transmission on Exposure to Flame, and the flammability according to JIS L 1091A-4 was as follows. Char length for warp: 8.7 cm, char length for weft: 8.4 cm, afterflame time for warp: 0 second, afterflame time for weft: 0 second, afterglow time for warp: 2.8 seconds, and afterglow time for weft: 3.1 seconds.

### INDUSTRIAL APPLICABILITY

The protective suit of the present invention is useful for work clothing worn by: fire fighters; ambulance crews; rescue workers; maritime lifeguards; military; workers at oil-related facilities; workers at chemical facilities, ironworks and shipyards; and welders.

1. A heat-resistant flame-retardant protective suit fabric formed of a uniform blended spun yarn comprising 25 to 75 mass % of polyetherimide fiber, 20 to 50 mass % of at least one fiber selected from wool and flame-retardant rayon, and 5 to 25 mass % of para-aramid fiber when the spun yarn is 100 mass %,
wherein the fabric experiences no heat shrinkage when exposed to a heat flux at 80 kW/m²±5% for 3 seconds in accordance with ISO 9151 Determination of Heat Transmission on Exposure to Flame, and
the char length is not more than 10 cm in the longitudinal and horizontal directions in the flammability test specified in JIS L 1091A-4.

2. The protective suit fabric according to claim 1, wherein the uniform blended spun yarn is formed of a two-fold yarn, a twist factor Ks₁ of a single yarn is in a range of 2560 to 2750, the two-fold yarn is twisted in a direction opposite to the direction for twisting the single yarn, and a twist factor K_{S2} of the two-fold yarn is in a range of 3490 to 3760,
where the twist factor Ks₁ of the single yarn and the twist factor Ks₂ of the two-fold yarn are calculated by equations below:
Ks₁=T₁·√S₁
Ks₂=T₂·√S₂
in the equations, T₁ indicates a twist number (time/m) of the single yarn, T₂ indicates a twist number (time/m) of the two-fold yarn, S₁ indicates a single yarn fineness (tex) and S₂ indicates a two-fold yarn fineness (tex).

3. The protective suit fabric according to claim 1, wherein the blended spun yarn further comprises an antistatic fiber.)

4. The protective suit fabric according to claim 1, which is either a knitted fabric or a woven fabric.

5. The protective suit fabric according to claim 1, wherein the polyetherimide fiber that forms the protective suit fabric has been dyed as a fiber, as a yarn or as a fabric, and the para-aramid fiber has been spun-dyed.

6. The protective suit fabric according to claim 1, wherein the uniform blended spun yarn comprises 25 to 74 mass % of polyetherimide fiber, 20 to 50 mass % of at least one fiber selected from wool and flame-retardant rayon, 5 to 25 mass % of para-aramid fiber, and 0.1 to 1 mass % of antistatic fiber.

7. The protective suit fabric according to claim 1, wherein the mass per unit of the protective suit fabric is in a range of 100 to 340 g/m².

8. A spun yarn used for a heat-resistant flame-retardant protective suit fabric,
wherein the spun yarn is a uniform blended spun yarn comprising 25 to 75 mass % of polyetherimide fiber, 20 to 50 mass % of at least one fiber selected from wool and flame-retardant rayon, and 5 to 25 mass % of para-aramid fiber when the spun yarn is 100 mass %.

9. The spun yarn according to claim 8, wherein the spun yarn is formed of a two-fold yarn, a twist factor Ks₁ of a single yarn is in a range of 2560 to 2750, the two-fold yarn is twisted in a direction opposite to the direction for twisting the single yarn, and a twist factor K_{S2} of the two-fold yarn is in a range of 3490 to 3760,
where the twist factor Ks₁ of the single yarn and the twist factor Ks₂ of the two-fold yarn are calculated by equations below:
Ks₁=T₁·√S₁
Ks₂=T₂·√S₂
in the equations, T₁ indicates a twist number (time/m) of the single yarn, T₂ indicates a twist number (time/m) of the two-fold yarn, S₁ indicates a single yarn fineness (tex) and S₂ indicates a two-fold yarn fineness (tex).

10. The spun yarn according to claim 8, wherein the blended spun yarn further comprises an antistatic fiber.

11. The spun yarn according to claim 10, wherein the content of the antistatic fiber is in a range of 0.1 to 1 mass %.
